(19) United States
(12) Patent Application Publication
(10) Pub. No.: US 2026/0046996 A1
(43) Pub. Date: Feb. 12, 2026

(54) NOZZLE COOLING IN A PLASMA ARC PROCESSING SYSTEM

(71) Applicant: Hypertherm, Inc., Hanover, NH (US)

(72) Inventors: Eric Brown, Charlestown, NH (US); David Ruest, Claremont, NH (US)

(21) Appl. No.: 19/293,426

(22) Filed: Aug. 7, 2025

Related U.S. Application Data
(60) Provisional application No. 63/680,167, filed on Aug. 7, 2024.

(51) Int. Cl. H05H 1/28; H05H 1/34

(52) U.S. Cl. CPC H05H 1/28; H05H 1/34

(57) ABSTRACT

A nozzle for a liquid-cooled plasma arc torch is provided. The nozzle includes an inner nozzle body defining a proximal end and a distal end extending along a central longitudinal axis of the nozzle. The inner nozzle body comprises a plasma bore disposed along the central longitudinal axis. An outer nozzle body is disposed about the inner nozzle body. The outer nozzle body and the inner nozzle body are joined at a distal interface to form a circumferential fluid seal. A liquid coolant channel defined between the inner nozzle body and the outer nozzle body. The liquid coolant channel is disposed substantially circumferentially into the inner nozzle body. A distal tip portion of the liquid coolant channel is located in the inner nozzle body between the distal interface and the plasma bore along a radial axis that is substantially perpendicular to the central longitudinal axis.

### CROSS REFERENCE TO RELATED APPLICATION

This application claims the benefit of and priority to U.S. Provisional Patent Application No. 63/680,167, filed on Aug. 7, 2024, the entire content of which is owned by the assignee of the instant application and incorporated herein by reference in its entirety.

### TECHNICAL FIELD

The present invention generally relates to one or more nozzle designs for a liquid-cooled plasma arc torch.

### BACKGROUND

Material Processing heads, such as plasma torches, water jet cutting heads, and laser heads, are widely used in the heating, cutting, gouging and marking of materials. For example, a plasma arc torch generally includes electrical connections, passages for cooling, passages for arc control fluids (e.g., plasma gas), and consumables, such as an electrode and a nozzle having a central exit orifice mounted within a torch body. Optionally, a swirl ring is employed to control fluid flow patterns in the plasma chamber formed between the electrode and the nozzle. In some plasma arc torches, a retaining cap can be used to maintain the nozzle and/or swirl ring in the torch body.

There are several performance issues associated with today's plasma arc torch, including poor cutting outcomes and inability to withstand operating environment temperatures. In particular, as shown in the prior art plasma arc torch tip 100 of FIG. 1, when the torch tip 100 does not receive adequate cooling, the O-ring 102 and the plastic nozzle jacket 104 of the torch tip 100 often melt prematurely due to excess heat in the operating environment, prior to expiration of life of other torch components.

In addition, when there is poor cooling (e.g., without the usage of a cooling jacket in a nozzle design), the bores of these nozzles often change in shape and size (e.g., cracking, largening, etc.) due to excessive stresses generated by heat cycling that occurs during plasma arc torch cutting. As shown in the prior art nozzle tip design of FIGS. 2a and 2b, where the image of FIG. 2a is a zoomed-in view of the nozzle tip 202 of the nozzle 200 of FIG. 2b, the region around the bore 204 of the nozzle 200 is severely damaged after performing 20-second starts for 1,080 times. The damage is caused by the stresses from extreme temperature swings during torch operation, which can lead to significant cracking and deformation of the nozzle bore 204.

Therefore, one or more nozzle designs are needed that offer sufficient cooling to support plasma arc torch operations (e.g., at 400 amperes or higher applications) to withstand the associated high temperatures generated.

### SUMMARY

The present invention features an “undercut” nozzle design according to which an undercut coolant path directs a coolant flow underneath an O-ring groove at the tip of the nozzle to enhance nozzle cooling. This design offers several advantages, including allowing the usage of an inexpensive, common plastic nozzle jacket and/or normal off-the-shelf O-rings in the nozzle by providing adequate cooling and thermal protection to these components that would otherwise melt under the same operating conditions, such at 400 amperes or higher (e.g., 460 amperes or higher).

In one aspect, a nozzle for a liquid-cooled plasma arc torch is provided. The nozzle includes an inner nozzle body defining a proximal end and a distal end extending along a central longitudinal axis of the nozzle. The inner nozzle body comprises a plasma bore disposed along the central longitudinal axis. The nozzle also includes an outer nozzle body disposed about the inner nozzle body. The outer nozzle body and the inner nozzle body are joined at a distal interface to form a circumferential fluid seal. The nozzle further includes a liquid coolant channel defined between the inner nozzle body and the outer nozzle body. The liquid coolant channel is disposed substantially circumferentially into the inner nozzle body. A distal tip portion of the liquid coolant channel is located in the inner nozzle body between the distal interface and the plasma bore along a radial axis that is substantially perpendicular to the central longitudinal axis.

In another aspect, a nozzle for a liquid-cooled plasma arc torch is provided. The nozzle includes an inner nozzle body comprising (i) a plasma bore disposed along a central longitudinal axis of the nozzle, (ii) an internal surface configured to form a portion of a plasma plenum, and (iii) an external surface configured to form a portion of a liquid coolant channel about the inner nozzle body. The liquid coolant channel comprises a distal tip portion disposed circumferentially within the inner nozzle body. The nozzle further includes an outer nozzle body disposed about the inner nozzle body and configured to complement the inner nozzle body to cooperatively define the liquid coolant channel about the inner nozzle body.

In yet another aspect, a tip for a liquid-cooled plasma arc torch is provided. The tip includes a nozzle including an inner nozzle body and an outer nozzle body disposed about the inner nozzle body. The nozzle defines a central longitudinal axis. The inner nozzle body comprises a plasma bore disposed along the central longitudinal axis, an internal surface configured to form a portion of a plasma plenum, and an external surface configured to form a portion of a liquid coolant channel about the inner nozzle body. The liquid coolant channel comprises a distal tip portion disposed circumferentially within the inner nozzle body. The outer nozzle body is configured to complement the inner nozzle body to cooperatively define the liquid coolant channel about the inner nozzle body. The torch tip also includes an electrode, at least a portion of which is disposed within the inner nozzle body of the nozzle. The torch tip further includes a shield configured to substantially surround an external surface of the outer nozzle body of the nozzle.

Any of the above aspects can include one or more of the following features. In some embodiments, the distal interface comprises at least one of a sealing element or a sealing groove forming the circumferential fluid seal. In some embodiments, the distal interface comprises a sealing member disposed between the inner nozzle body and the outer nozzle body. The sealing member has a diameter of between about 0.15 inches and 0.3 inches.

In some embodiments, the distal tip portion of the liquid coolant channel axially extends under the circumferential fluid seal for at least about 30% of an axial width of the circumferential fluid seal. In some embodiments, the distal tip portion of the liquid coolant channel axially extends forward to within about 0.12 inches from the distal end of the inner nozzle body parallel to the central longitudinal axis. In some embodiments, the distal tip portion of the liquid coolant channel radially extends inward along the radial axis to within about 0.065 inches from an inner surface of the plasma bore. In some embodiments, the distal tip portion of the liquid coolant channel radially extends inward along the radial axis to within about 0.115 inches from the central longitudinal axis.

In some embodiments, the liquid coolant channel is radially defined by only the inner nozzle body. In some embodiments, the liquid coolant channel is configured to induce impingement of a turbulent coolant flow therein.

In some embodiments, the outer nozzle body comprises brass or plastic. In some embodiments, an internal surface of the inner nozzle body is configured to partially define a plasma plenum, and the liquid coolant channel is located axially forward of the plasma plenum. In some embodiments, the nozzle is configured to operate at an electrical current level of above about 120 A.

It should also be understood that various aspects and embodiments of the invention can be combined in various ways. Based on the teachings of this specification, a person of ordinary skill in the art can readily determine how to combine these various embodiments. For example, in some embodiments, any of the aspects above can include one or more of the above features. One embodiment of the invention can provide all of the above features and advantages.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows a prior art plasma arc torch tip.

FIGS. 2a and 2b show a prior art nozzle for a plasma arc torch.

FIG. 3 shows an exemplary nozzle with enhanced cooling features for a liquid-cooled plasma arc torch, according to some embodiments of the present invention.

FIG. 4 shows in detail the region within which the distal tip portion of the liquid coolant channel of the nozzle of FIG. 3 can be located, according to some embodiments of the present invention.

FIG. 5 shows another detailed view of the nozzle of FIG. 3, according to some embodiments of the present invention.

FIG. 6 shows an exemplary nozzle, designed based on the nozzle of FIG. 3, after 1,080 20-second starts during testing, according to some embodiments of the present invention.

FIGS. 7a and 7b show exemplary thermal analysis images for a prior art nozzle and the nozzle design of FIG. 3, respectively, according to some embodiments of the present invention.

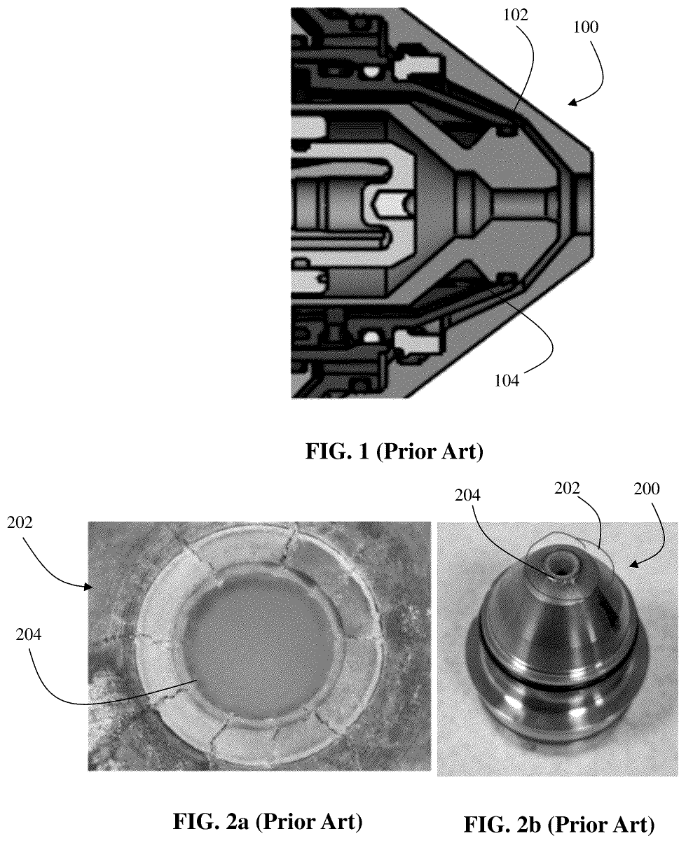

### DETAILED DESCRIPTION

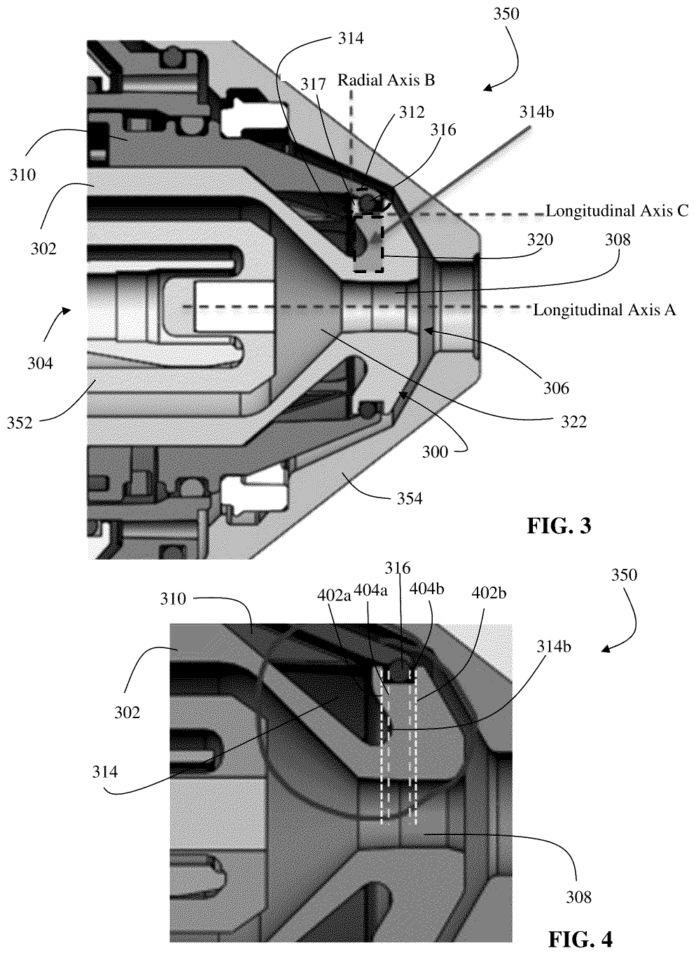

FIG. 3 shows an exemplary nozzle 300 with enhanced cooling features for a liquid-cooled plasma arc torch 350, according to some embodiments of the present invention. As shown, the nozzle 300 is a two-piece nozzle comprising an inner nozzle body 302 and an outer nozzle body 310. The inner nozzle body 302 defines a proximal end 304 and a distal end 306 extending along a central longitudinal axis A of the nozzle 300. In the context of the present invention, the distal end 306 is defined as the end that is closest to a workpiece (not shown) when the plasma arc torch is used to process the workpiece, and the proximal end 304 is the end that is opposite of the distal end 306 along the central longitudinal axis A. The inner nozzle body 302 includes a central plasma bore 308 disposed along and extending through the central longitudinal axis A at the distal end 306 of the nozzle 300. In some embodiments, an internal surface of the inner nozzle body 302 is configured to partially define a plasma plenum 322 located proximal to the plasma bore 308. In addition, the outer nozzle body 310 of the nozzle 300 is disposed about an external surface of the inner nozzle body 302. The outer nozzle body 310 can serve as a “jacket” of the nozzle 300. In some embodiments, the outer nozzle body 310 is made from brass or plastic. In some embodiments, the nozzle 100 is configured to operate under an electric current of above about 120 amps, such at 400 amps or higher (e.g., 450 amps or higher).

As shown, the outer nozzle body 310 and the inner nozzle body 302 are configured to be joined at a distal interface 312 to form a circumferential fluid seal. In some embodiments, a sealing element 316 is located within a sealing groove 317, both of which disposed at the distal interface 312 to form the circumferential fluid seal. For example, the sealing element 316 can be an O-ring made of plastic and/or rubber. The sealing member 316 can have a thickness/diameter of between about 0.15 inches and about 0.3 inches.

In some embodiments, a liquid coolant channel 314 is formed between the inner nozzle body 302 and the outer nozzle body 310 and configured to, for example, induce impingement of a turbulent coolant flow therein. The liquid coolant channel 314 is disposed substantially circumferentially about the exterior surface of the inner nozzle body 302, such as disposed into a portion of the inner nozzle body 302 from its exterior surface. In some embodiments, the liquid coolant channel 314 is radially defined by only the inner nozzle body 302. In addition, the liquid coolant channel 312 is located axially distal of the plasma plenum 322 (e.g., axially forward of the plasma plenum 322). As shown in FIG. 3, the distal tip portion 314b of the liquid coolant channel 314 can be located in the inner nozzle body 302 between the distal interface 312 and the plasma bore 308 along a radial axis B, which is defined as an axis that is substantially perpendicular to the central longitudinal axis A and substantially aligned with the concave support structure of the sealing groove 317 of the inner nozzle body 302 that houses the sealing element 316. In addition, in the context of the present invention, longitudinal axis C is defined as an axis parallel to the central longitudinal axis A and substantially aligned with the bottom of the sealing element/groove 316, 317, as shown in FIG. 3.

The liquid coolant channel 314, including its distal tip portion 314b, is configured to conduct a liquid coolant flow (e.g., water) close to the plasma bore 308 as well as close to the sealing element 316 and/or the outer nozzle body 310 to prevent excessive heating of these nozzle elements. In particular, the distal tip portion 314b of the liquid coolant channel 314 forms an undercut relative to the sealing element/groove 316, 317 along radial axis B. This distal tip portion 314b, when cut sufficiently deep along the axial direction (i.e., along the direction parallel to longitudinal axes A and C), is effective in keeping the nozzle temperature low to prevent cracking (as illustrated in the prior art nozzle tip 202 of FIG. 2), as well as prevent the plastic and/or rubber sealing element 316 and/or the plastic jacket outer nozzle body 310 from melting.

More particularly, the distal tip portion 314b, which represents an undercut for cooling purposes as described above, can be located in a region 320 that is (i) axially bounded proximally by radial axis B and (ii) radially bounded between longitudinal axes C and A. FIG. 4 illustrates in detail the region 320 within which the distal tip portion 314b of the liquid coolant channel 314 of the nozzle 300 of FIG. 3 can be located, according to some embodiments of the present invention. To achieve the desired cooling results, the “undercut” distal tip portion 314b can at least partially radially extend between the sealing groove 317 and plasma bore 308, and at least partially axially extend within the axial width of the sealing groove 317 (i.e., between axes 402a and 402b). In some embodiments, the “undercut” distal tip portion 314b radially extends beneath the sealing element 316 and axially extends within the diameter of the sealing element 316 (i.e., between axes 404a and 404b). In some embodiments, the distal tip portion 314b of the liquid coolant channel 314 axially extends for at least about 30% of an axial width of the sealing groove 317 or the sealing element 318. These configurations permit the coolant flowing through the distal tip portion 314b to extract heat from the distal interface region 312, thereby prolonging the lives of various nozzle components. This is particularly important in a nozzle configuration that utilizes a nozzle jacket, such as the nozzle configuration disclosed in U.S. Pat. No. 9,867,268, which is owned by the assignee of the instant invention and incorporated herein by reference in its entirety. In such jacketed nozzle designs, as exemplified in the nozzle 300 of FIG. 3, the inner nozzle body 302, which may be made of an electrically conductive material (e.g., copper), is adapted to seal against the tip of the jacketed outer nozzle body 310 at the sealing element 316 (e.g., an O-ring). This O-ring to jacket distal interface 312 prevents the coolant from leaking out of the nozzle 300 and into the plasma stream. The undercut coolant channel design of nozzle 300 is able to keep this interface 312 cool and the O-ring 316 thermally secure and/or regulated. Consequently, the undercut coolant channel design permits the use of a standard O-ring 316 versus a high temperature O-ring in nozzle 300, which can cost about 100 times that of a standard O-ring.

Referring back to FIG. 3, in addition to the two-piece nozzle 300, the plasma arc torch 350 can also includes an electrode 352 with at least a portion disposed within a cavity defined by the inner nozzle body 302 of the nozzle 300. The torch 350 can further include a shield 354 configured to substantially surround an external surface of the outer nozzle body 310 of the nozzle 300.

FIG. 5 shows another detailed view of the nozzle 300 of FIG. 3, according to some embodiments of the present invention. In some embodiments, the liquid coolant channel 314, including its distal tip portion 314b, is configured to flow the liquid coolant to within a radial distance 502 of less than about 0.065 inches of an inner surface of the plasma bore 308. That is, the distal tip portion 314b can radially extend inward along radial axis B to within about the distance 502 of about 0.065 inches or less from the inner surface of the plasma bore 308. In some embodiments, the radial distance 502 is between about 0.055 inches and about 0.06 inches. In some embodiments, the liquid coolant channel 314, including its distal tip portion 314b, radially extends inward along radial axis B to within a radial distance 504 of about 0.115 inches from the central longitudinal axis B. In some embodiments, the radial distance 504 is between about 0.115 inches and about 0.12 inches. In some embodiments, the liquid coolant channel 314, including its distal tip portion 314b, axially extends forward parallel to longitudinal axes A and C to within about an axial distance 506 of about 0.12 inches from the distal end 306 of the inner nozzle body 302. In some embodiments, the axial distance 506 is between about 0.12 inches and about 0.13 inches.

In some embodiments, nozzle 300 is formed as a unitary body such that inner nozzle body 302 and outer nozzle body 310 have a unitary construction (e.g., are formed from a unitary piece of material or being a unitary device in final construction). This construction is distinct from a traditional jacketed plasma nozzle, which includes a two-piece assembly to create a desired flow profile and thermal regulation. However, this two-piece traditional configuration can increase required assembly labor, which in turn increases cost and even decreases alignment accuracy and sealing of the components. Embodiments of nozzles 300 having a unitary body can create a similar or an improved flow profile using a single piece as well as more secure fluid seals and construction, which may lower manufacturing cost and/or improve performance. Manufacturing can be carried out using a traditional turning operation or an additive manufacturing process (e.g., 3D printing operation). The flow passages can have varying geometries, shapes, angles, or features to improve the cutting performance, reduce gas usage, or both. Nozzle 300 can include a unitary body, which may be produced via many methods such as three-dimensional printing. In some other embodiments, outer nozzle body 310 is comprised as a part of a retaining cap and not an integral part of nozzle 300. In these embodiments, inner nozzle body 302 comprises an inner nozzle which is separable in the field and during maintenance and repairs from outer nozzle body 310 such that in operation a single outer nozzle body 310 may be useable with several inner nozzle bodies 302 before outer nozzle body 310 reaches end of life. In some of these embodiments, outer nozzle body 310 may be attached/connected to a retaining cap of the plasma arc torch and may only seal/affix to the outer surfaces of inner nozzle body 302 upon installation into the plasma arc torch and may be removable with the retaining cap upon disassembly.

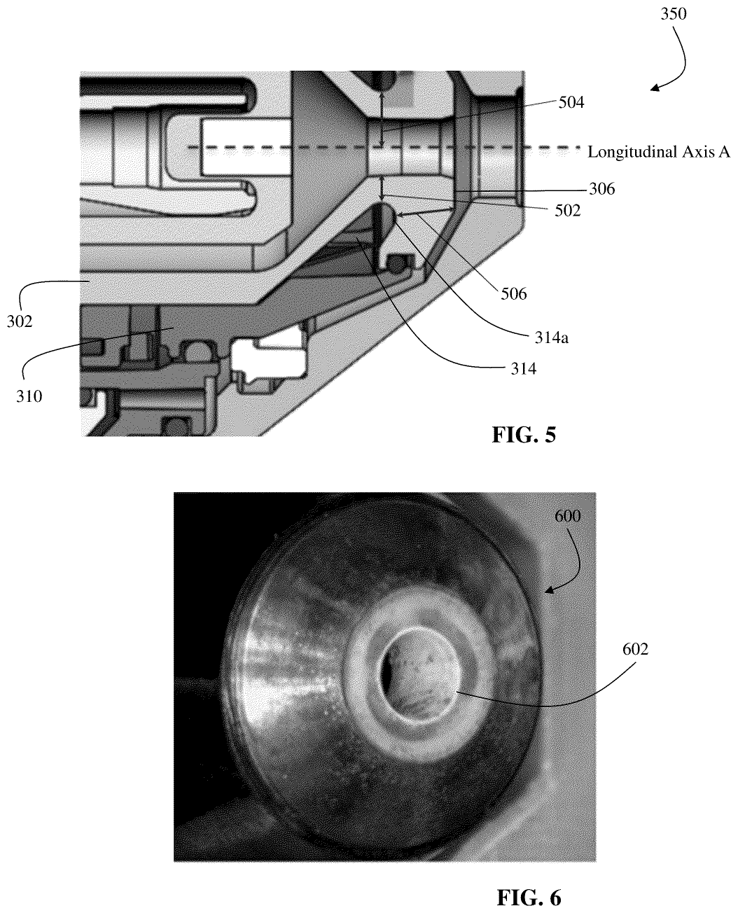

FIG. 6 shows an exemplary nozzle 600, designed based on the nozzle 300 of FIG. 3, after 1,080 20-second starts during testing, according to some embodiments of the present invention. As shown, the nozzle 600 has no noticeable cracking around the plasma bore 602, in contrast to the prior art nozzle 200 shown in FIGS. 2a and 2b. Such an undercut jacketed nozzle design 300 is adapted to force coolant flow underneath the sealing element 316 and the sealing groove 317, thereby protecting the sealing element 316 from melting and providing adequate cooling to prevent nozzle bore cracking.

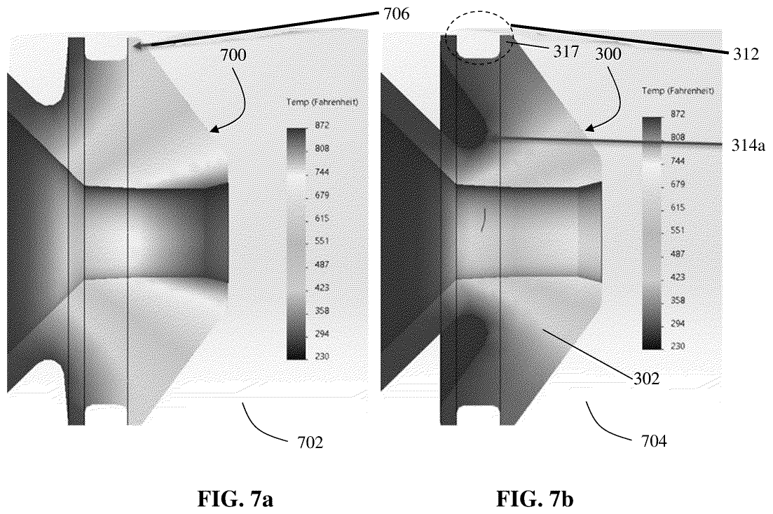

FIGS. 7a and 7b show exemplary thermal analysis images 702, 704 of a prior art nozzle 700 and the nozzle 300 of FIG. 3 (that incorporates the coolant channel undercut design), respectively, according to some embodiments of the present invention. In particular, the thermal analysis 704 of the undercut nozzle design 300 shows that not only is the distal interface region 312 (including the sealing element 316 and the sealing groove 317) cooler in comparison to the prior art nozzle 700 without the coolant undercut design, but also the entire tip of the nozzle 300 is cooler by comparison. For example, the temperature of the seat flange of the inner nozzle body 302 forming the sealing groove 317 in the thermal analysis 704 for the undercut design is about 400 degrees Fahrenheit, whereas the same seat flange 706 in the prior art nozzle 700 is about 450 degrees Fahrenheit. In general, the undercut design 300 shows better temperature performance, where the entire nozzle tip is heated to less than about 300 degrees Fahrenheit, which prevents extrusion of the sealing element 316 as well as protect the plastic “jacket”/outer nozzle body 310.

One of the benefits of the coolant channel undercut design of nozzle 300 is that the plasma bore 308 is adapted to maintain its shape and size during plasma processing, thereby ensuring consistent cut quality throughout the life of the nozzle. In addition, for nozzle 300, consumable blowouts at the end of life tend to be mild due to the grooved distal tip portion 314b of the liquid coolant channel 314 that acts as a mechanical “fuse” to allow the coolant to leak into the plenum 322, thereby rapidly extinguishing the plasma arc therein, which limits blowout damage and provides incidental mechanical torch protection. The common end of life failure mode for nozzles incorporating embodiments of the present invention is the development of a small hole through inner nozzle body 302 proximate distal tip portion 314b (e.g., along radial distance 502, the thinnest portion of the nozzle directly exposed to the plenum and arc) where coolant begins to leak inwardly into the plasma plenum. Essentially, upon thermal degradation and failure of the nozzle the system fails inward with coolant flowing into the plenum and/or arc and essentially shorting the system and preventing the traditionally experienced torch blowout of consumables which can significantly damage and/or destroy the torch and the workpiece. Additionally, significant cost savings can be achieved by using a common plastic jacket/outer nozzle body 310 and off-the-shelf standard O-ring 316 in the undercut nozzle design of the present invention. In some embodiments, the jacket/outer nozzle body 310 of the nozzle 300 is produced using an injection molding technique, which is more cost effective than previous brass jackets and other designs. In some embodiments, the off-the-shelf standard O-ring 316 in the nozzle 300 can cost 100 times less than a high-temperature specialized O-ring.

It should be understood that various aspects and embodiments of the invention can be combined in various ways. Based on the teachings of this specification, a person of ordinary skill in the art can readily determine how to combine these various embodiments. Modifications may also occur to those skilled in the art upon reading the specification.

What is claimed is:

1. A nozzle for a liquid-cooled plasma arc torch, the nozzle comprising:
an inner nozzle body defining a proximal end and a distal end extending along a central longitudinal axis of the nozzle, the inner nozzle body comprising a plasma bore disposed along the central longitudinal axis;
an outer nozzle body disposed about the inner nozzle body, the outer nozzle body and the inner nozzle body joined at a distal interface to form a circumferential fluid seal; and
a liquid coolant channel defined between the inner nozzle body and the outer nozzle body, the liquid coolant channel disposed substantially circumferentially into the inner nozzle body, a distal tip portion of the liquid coolant channel located in the inner nozzle body between the distal interface and the plasma bore along a radial axis that is substantially perpendicular to the central longitudinal axis.

2. The nozzle of claim 1, wherein the distal interface comprises at least one of a sealing element or a sealing groove forming the circumferential fluid seal.

3. The nozzle of claim 1, wherein the distal interface comprises a sealing member disposed between the inner nozzle body and the outer nozzle body, the sealing member having a diameter of between about 0.15 inches and 0.3 inches.

4. The nozzle of claim 1, wherein the distal tip portion of the liquid coolant channel axially extends under the circumferential fluid seal for at least about 30% of an axial width of the circumferential fluid seal.

5. The nozzle of claim 1, wherein the liquid coolant channel is radially defined by only the inner nozzle body.

6. The nozzle of claim 1, wherein the distal tip portion of the liquid coolant channel radially extends inward along the radial axis to within about 0.065 inches from an inner surface of the plasma bore.

7. The nozzle of claim 1, wherein the distal tip portion of the liquid coolant channel radially extends inward along the radial axis to within about 0.115 inches from the central longitudinal axis.

8. The nozzle of claim 1, wherein the distal tip portion of the liquid coolant channel axially extends forward to within about 0.12 inches from the distal end of the inner nozzle body parallel to the central longitudinal axis.

9. The nozzle of claim 1, wherein the outer nozzle body comprises brass or plastic.

10. The nozzle of claim 1, wherein the nozzle is configured to operate at an electrical current level of above about 120A.

11. The nozzle of claim 1, wherein the liquid coolant channel is configured to induce impingement of a turbulent coolant flow therein.

12. The nozzle of claim 1, wherein an internal surface of the inner nozzle body is configured to partially define a plasma plenum, and wherein the liquid coolant channel is located axially forward of the plasma plenum.

13. A nozzle for a liquid-cooled plasma arc torch, the nozzle comprising:
an inner nozzle body comprising:
a plasma bore disposed along a central longitudinal axis of the nozzle;
an internal surface configured to form a portion of a plasma plenum; and
an external surface configured to form a portion of a liquid coolant channel about the inner nozzle body, the liquid coolant channel comprising a distal tip portion disposed circumferentially within the inner nozzle body; and
an outer nozzle body disposed about the inner nozzle body and configured to complement the inner nozzle body to cooperatively define the liquid coolant channel about the inner nozzle body.

14. The nozzle of claim 13, wherein the distal tip portion of the liquid coolant channel radially extends inward along the radial axis to within about 0.065 inches from an inner surface of the plasma bore.

15. The nozzle of claim 13, wherein the distal tip portion of the liquid coolant channel axially extends forward to within about 0.12 inches from the distal end of the inner nozzle body parallel to the central longitudinal axis.

16. The nozzle of claim 13, wherein the outer nozzle body comprises brass or plastic.

17. The nozzle of claim 13, further comprising a sealing interface formed between the inner nozzle body and the outer nozzle body at a distal end of the nozzle, the sealing interface including at least one of a sealing element or a sealing groove.

18. The nozzle of claim 13, wherein the liquid coolant channel extends axially forward into the inner nozzle body such that the distal tip portion of the liquid coolant channel is radially between the plasma bore and the sealing interface along a radial axis that is substantially perpendicular to the central longitudinal axis.

19. The nozzle of claim 18, wherein the distal tip portion of the liquid coolant channel radially extends inward along the radial axis to within about 0.115 inches from the central longitudinal axis.

20. The nozzle of claim 13, wherein the distal tip portion of the liquid coolant channel axially extends under the circumferential fluid seal for at least about 30% of an axial width of the circumferential fluid seal.

21. A tip for a liquid-cooled plasma arc torch, the tip comprising:
a nozzle including an inner nozzle body and an outer nozzle body disposed about the inner nozzle body, the nozzle defining a central longitudinal axis, the inner nozzle body comprising:
a plasma bore disposed along the central longitudinal axis;
an internal surface configured to form a portion of a plasma plenum; and
an external surface configured to form a portion of a liquid coolant channel about the inner nozzle body, the liquid coolant channel comprising a distal tip portion disposed circumferentially within the inner nozzle body, wherein the outer nozzle body is configured to complement the inner nozzle body to cooperatively define the liquid coolant channel about the inner nozzle body;
an electrode, at least a portion of which is disposed within the inner nozzle body of the nozzle; and
a shield configured to substantially surround an external surface of the outer nozzle body of the nozzle.
